(19) United States
(12) Patent Application Publication
(10) Pub. No.: US 2026/0233519 A1
(43) Pub. Date: Aug. 13, 2026

(54) MANUFACTURING METHOD FOR SEMICONDUCTOR SUBSTRATE, MANUFACTURING METHOD FOR LIQUID EJECTION HEAD, SEMICONDUCTOR SUBSTRATE, AND LIQUID EJECTION HEAD

(71) Applicant: CANON KABUSHIKI KAISHA, Tokyo (JP)

(72) Inventors: KENJI TAMAMORI, Kanagawa (JP); MASATAKA NAGAI, Kanagawa (JP)

(21) Appl. No.: 19/531,500

(22) Filed: Feb. 5, 2026

(30) Foreign Application Priority Data
Feb. 12, 2025 (JP) 2025-020732

(51) Int. Cl. B41J 2/14; B41J 2/16; B41J 2/165

(52) U.S. Cl. CPC B41J 2/14072; B41J 2/14112; B41J 2/1603; B41J 2/16517; B41J 2002/16561

(57) ABSTRACT

A method for manufacturing a semiconductor substrate that includes, on a substrate, a first electrode, a second electrode having an area larger than that of the first electrode, a first electrode pad connected to the first electrode via a first connection portion, and a second electrode pad connected to the second electrode via a second connection portion, includes forming these electrodes and connection portions each including a third metal film on the substrate, forming a second metal film having a standard electrode potential lower than that of the third metal film in a region including these electrodes, these connection portions, forming a first metal film having a standard electrode potential higher than that of the second metal film on the second film, and forming these pads by patterning the first and second metal film, wherein, during the forming these pads, these electrodes and pads are exposed to an electrolyte.

### BACKGROUND

### Field of the Technology

The present disclosure relates to a manufacturing method for a semiconductor substrate, a manufacturing method for a liquid ejection head, a semiconductor substrate, and a liquid ejection head.

### Description of the Related Art

Structures obtained by microfabricating semiconductor substrates are widely used in functional elements in micro-electromechanical systems (MEMS) and other fields. One example is a liquid ejection head that ejects and deposits droplets on a recording medium to perform recording and the like. Some liquid ejection heads eject liquid from ejection ports using pressure generated by energizing energy generating elements such as heating resistance elements, piezoelectric elements and the like, and include semiconductor substrates equipped with energy generating elements and flow path members that form ejection ports and liquid flow paths. The energy generating element is driven by being supplied with an electrical signal and a voltage from a liquid ejection apparatus via an electrode pad provided on the semiconductor substrate.

The electrode pad on the semiconductor substrate generally has a structure in which a plurality of types of metals is laminated. It is known that if the laminated metals of different types come into contact with an electrolyte, a potential difference occurs between the metals, forming a local cell, resulting in galvanic corrosion, which accelerates dissolution of the metal with a higher ionization tendency. In a case of an electrode pad having a laminated structure formed of a noble metal and a base metal, if the noble metal and the base metal are exposed to an electrolyte while in contact with each other, the base metal (the metal with a relatively higher ionization tendency) is subjected to significant etching due to galvanic corrosion. Accordingly, if side etching of the base metal film reaches an opening of a passivation film on the electrode pad, there is a concern that the reliability of wiring connected to the electrode pad through the opening may be reduced. For example, if a wiring layer becomes exposed, contact with the etchant may cause deterioration or disconnection of the wiring. Further, even if the wiring is not exposed, there is a possibility that, over time, contact with the etchant at the interface with the passivation film may cause deterioration of the wiring.

With respect to an issue of excessive side etching of a base metal film, Japanese Patent Application Laid-Open No. 2005-223719 describes that a base metal with a higher ionization tendency among laminated metals is disposed as an electrolytic corrosion suppression pattern on a noble metal layer of an element outside a device region. Accordingly, a method for suppressing side etching of a device portion is described.

If the electrolytic corrosion suppression pattern is provided on the noble metal layer around the element as described in Japanese Patent Application Laid-Open No. 2005-223719 in order to maintain the reliability of the wiring on the semiconductor substrate, there is a concern that this will increase chip size and manufacturing costs due to the increased number of manufacturing processes.

### SUMMARY

The present disclosure is directed to the provision of a semiconductor substrate with improved wiring reliability and a method for manufacturing the same in consideration of the above-described issues.

According to an aspect of the present disclosure, a method for manufacturing a semiconductor substrate that includes, on a substrate, a first electrode, a second electrode having an area larger than that of the first electrode, a first electrode pad connected to the first electrode via a first connection portion, and a second electrode pad connected to the second electrode via a second connection portion, includes forming the first electrode, the second electrode, and the first connection portion and the second connection portion each including a third metal film on the substrate, forming a second metal film having a standard electrode potential lower than that of the third metal film in a region including the first electrode, the second electrode, the first connection portion, and the second connection portion, forming a first metal film having a standard electrode potential higher than that of the second metal film on the second metal film, and forming the first electrode pad and the second electrode pad by patterning the first metal film and the second metal film, wherein, during the forming the first electrode pad and the second electrode pad, the first electrode, the second electrode, the first electrode pad, and the second electrode pad are exposed to an electrolyte.

According to another aspect of the present disclosure, a method for manufacturing a semiconductor substrate that includes, on a substrate, a first electrode, a second electrode, a first electrode pad connected to the first electrode via a first connection portion, and a second electrode pad connected to the second electrode via a second connection portion, includes forming the first electrode, the first connection portion, and the second connection portion from a third metal film, forming the second electrode from a fourth metal film having a standard electrode potential higher than that of the third metal film, forming a second metal film having a standard electrode potential lower than that of the third metal film in a region including the first electrode, the second electrode, the first connection portion, and the second connection portion, forming a first metal film having a standard electrode potential higher than that of the second metal film on the second metal film, and forming the first electrode pad and the second electrode pad by patterning the first metal film and the second metal film, wherein, during the forming the first electrode pad and the second electrode pad, the first electrode, the second electrode, the first electrode pad, and the second electrode pad are exposed to an electrolyte.

Features of the present disclosure will become apparent from the following description of embodiments with reference to the attached drawings. The following description of embodiments is described by way of example.

### BRIEF DESCRIPTION OF THE DRAWINGS

FIG. 1A is a plan view illustrating a liquid ejection head according to a first embodiment.

FIG. 1B is a cross-sectional perspective view illustrating the liquid ejection head according to the first embodiment.

FIGS. 2A to 2G illustrate parts of a manufacturing process for a semiconductor substrate according to the first embodiment.

FIG. 3A is a plan view illustrating the semiconductor substrate according to the first embodiment.

FIGS. 3B and 3C are cross-sectional views illustrating the semiconductor substrate according to the first embodiment.

FIGS. 4A and 4B are schematic diagrams illustrating galvanic corrosion in a case where a semiconductor substrate is immersed in an electrolyte.

FIGS. 5A to 5G illustrate parts of a manufacturing process for the semiconductor substrate according to the first embodiment.

FIG. 6A is a plan view illustrating a semiconductor substrate according to a second embodiment.

FIGS. 6B and 6C are cross-sectional views illustrating the semiconductor substrate according to the second embodiment.

FIGS. 7A to 7G illustrate parts of a manufacturing process for the semiconductor substrate according to the second embodiment.

### DESCRIPTION OF THE EMBODIMENTS

Embodiments of the present disclosure will be described below with reference to the attached drawings. The same configurations are described with the same reference numerals. Further, relative arrangement, shapes, and the likes of components described in the embodiments are merely examples.

In the following description, a liquid ejection head that uses a semiconductor substrate according to the present disclosure is described as an example. However, the semiconductor substrate to which the present disclosure can be applied is not limited to the liquid ejection head.

### First Embodiment

### (Configuration of Liquid Ejection Head)

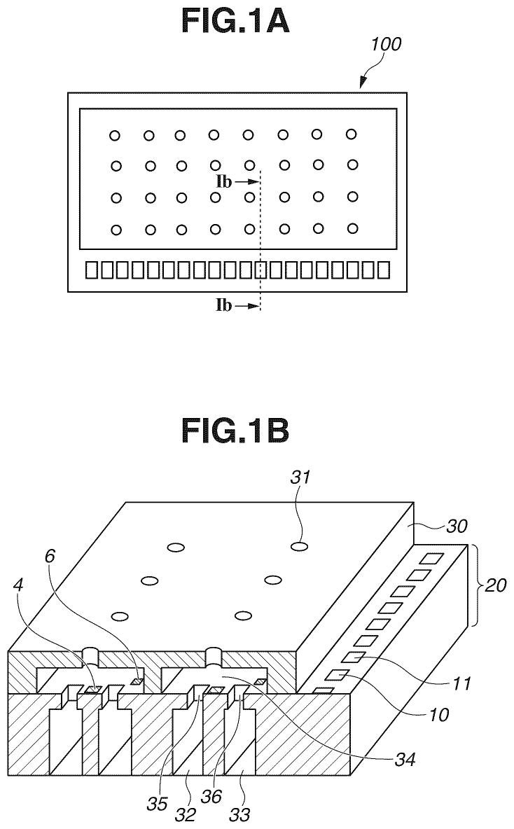

FIGS. 1A and 1B are schematic diagrams illustrating a liquid ejection head as an embodiment to which the present disclosure can be applied. FIG. 1A is a plan view of a liquid ejection head 100. FIG. 1B is a cross-sectional perspective view of the liquid ejection head 100 taken along line Ib-Ib in FIG. 1A.

The liquid ejection head 100 includes a nozzle plate 30 equipped with ejection ports 31 for ejecting liquid and a substrate 20 that is a semiconductor substrate equipped with an energy generating element 4 that generates energy for ejecting liquid from the ejection port 31. The nozzle plate 30 is formed on the substrate 20 (on the substrate) and forms an individual liquid chamber 34 for supplying liquid to each of the ejection ports 31. According to the present embodiment, the substrate 20 is a silicon (Si) substrate and includes common flow paths 32 and 33, a through hole 35 that connects the common flow path 32 and the individual liquid chamber 34, and a through hole 36 that connects the common flow path 33 and the individual liquid chamber 34.

The liquid supplied to the common flow path 32 passes through the through hole 35 and is supplied to the individual liquid chamber 34. By applying an electrical signal to a first electrode pad 10 electrically connected to the energy generating element 4, the liquid is ejected from the ejection port 31. Further, the liquid that is not ejected flows from the individual liquid chamber 34 through the through hole 36 to the common flow path 33. The substrate 20 may be configured to supply the liquid to the individual liquid chamber 34 from both the through holes 35 and 36, or may be configured without the through hole 36 and the common flow path 33.

### (Method for Manufacturing Semiconductor Substrate)

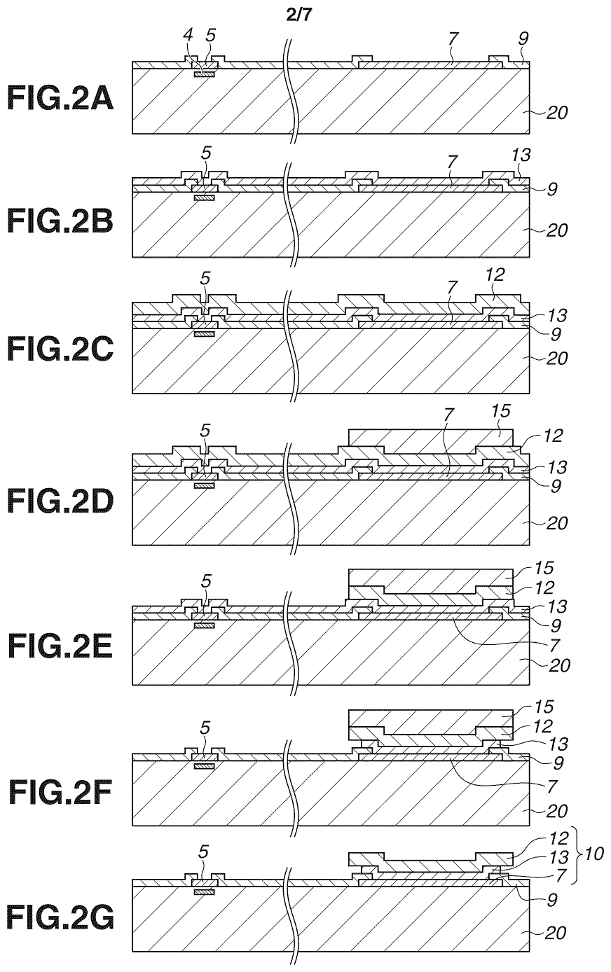

A method for manufacturing the substrate 20 according to the present embodiment is described with reference to FIGS. 2A to 2G. FIGS. 2A to 2G are cross-sectional views illustrating a process for forming the energy generating element 4 and the first electrode pad 10.

First, as illustrated in FIG. 2A, the substrate 20 is prepared on which a third metal film forming a first connection portion 7 of the first electrode pad 10 and the energy generating element 4 are provided. The substrate 20 further includes a first electrode 5 located above the energy generating element 4 in a direction perpendicular to a surface of the substrate 20. In other words, the energy generating element 4 is located below the first electrode 5 in the direction perpendicular to the surface of the substrate 20. The energy generating element 4 and the third metal film (first connection portion 7) are electrically connected by wiring (not illustrated). A passivation film 9 is formed so as to cover the wiring (not illustrated), and the first electrode 5 and the third metal film (first connection portion 7) are exposed from the passivation film 9. According to the present embodiment, silicon carbide (SiC) is used as an example of a material of the passivation film 9, but other materials may also be used as long as they have insulating properties. For example, silicon oxide and silicon nitride may be used.

The third metal film (first connection portion 7) is an electrical connection portion between the wiring and the first electrode pad 10 and a second electrode pad 11 described below, so that it is desirable to use a metal or a metal compound with good electrical conductivity. According to the present embodiment, iridium is used as an example of a material of the third metal film, but other materials may also be used.

Since the first electrode 5 is a portion exposed from the passivation film 9, it is desirable to use a material that is resistant to a manufacturing process. The first electrode 5 according to the present embodiment is an iridium film formed of the same layer as the third metal film. Other noble metals including palladium, platinum, and the like may also be used. The standard electrode potentials of these metals are +1.16 V for iridium, +0.987 V for palladium, and +1.188 V for platinum. The third metal film can be formed using an arbitrary method, such as sputtering film deposition or vacuum vapor film deposition.

Next, as illustrated in FIG. 2B, a second metal film 13 is formed in a region including at least the first electrode 5, a second electrode 6, and the third metal film, which is the first connection portion 7. The second metal film 13 functions as a diffusion prevention layer and an adhesion improvement layer in the first electrode pad 10. Thus, it is desirable that the second metal film 13 is made of a metal or a metal compound that has excellent adhesion to the third metal film (first connection portion 7) and a first metal film 12 to be formed later, is stable at high temperatures, is resistant to atomic diffusion, is chemically stable, and has relatively low resistivity. According to the present embodiment, titanium tungsten is used as a material of the second metal film 13, but other materials may also be used. The second metal film 13 can be formed using an arbitrary method, such as sputtering film deposition, vacuum vapor film deposition, or chemical vapor deposition.

Next, as illustrated in FIG. 2C, the first metal film 12 is formed on the second metal film 13. The first metal film 12 serves as a wiring lead-out portion of the first electrode pad 10 and functions as a contact point with the outside of the liquid ejection head 100 via wire bonding, bump connection, or the like. It is desirable that the first metal film 12 is made of a metal or a metal compound that has good electrical conductivity and good connectivity as a contact point for wiring lead-out. According to the present embodiment, gold is used as a material of the first metal film 12, but other materials may also be used. The first metal film 12 can be formed using a method, such as sputtering film deposition, vacuum vapor film deposition, or plating.

Subsequently, as illustrated in FIG. 2D, a mask pattern 15 in order to form the first electrode pad 10 is formed on the first metal film 12. The mask pattern 15 is formed of, for example, a photoresist. The photoresist is applied onto the first metal film 12 by spin coating or the like, and then pre-baked. Subsequently, the substrate 20 is exposed in an exposure apparatus using a photomask on which the pattern of the first electrode pad 10 is formed and developed to form the mask pattern 15. A photoresist material that is resistant to a subsequent etching process may be selected for a material of the mask pattern 15, and a film thickness of the mask pattern 15 may be set to a film thickness that is sufficient to protect portions that are not subjected to etching in the subsequent etching process. The photoresist may be of a positive type, a negative type, or a chemically amplified type.

Next, as illustrated in FIG. 2E, the first metal film 12 is etched in an opening portion of the mask pattern 15. The first metal film 12 can be etched using, for example, a wet etching method using an electrolyte.

Subsequently, as illustrated in FIG. 2F, the second metal film 13 is etched in the opening portion of the mask pattern 15. At this time, the second metal film 13 is etched using the mask pattern 15 and the first metal film 12 as a mask. The second metal film 13 can be etched using, for example, a wet etching method using an electrolyte.

Next, as illustrated in FIG. 2G, the mask pattern 15 is removed. The mask pattern 15 can be removed, for example, using an electrolyte. For example, the substrate 20 is immersed in a resist stripping solution to remove the mask pattern 15, and then the resist stripping solution is washed away with a rinse solution.

### (Electrical Reliability of First Electrode Pad)

Here, if the second metal film 13 is patterned by wet etching as illustrated in FIG. 2F, the second metal film 13 is etched not only in its thickness direction but also in a horizontal direction in the drawing (hereinbelow, referred to as “side etching”). Further, a laminated film of metals with different compositions, such as the first electrode pad 10 according to the present embodiment in which the first metal film 12, the second metal film 13, and the third metal film (first connection portion 7) are laminated may undergo galvanic corrosion in an electrolytic environment. This can result in an increased side etching amount. If the side etching of the metal film forming the first electrode pad 10 reaches the opening portion of the passivation film 9, there is a concern that the electrical reliability of the substrate 20 may be reduced. For example, if the wiring (not illustrated) becomes exposed from the passivation film 9, the wiring may come into contact with an etching agent (etchant) during etching, possibly causing deterioration or disconnection. Further, even if the wiring is not exposed, there is a possibility that, over time, the etchant that has entered through an interface between the passivation film 9 and the second metal film 13 may come into contact with the wiring and cause it to deteriorate.

Thus, in order to ensure the electrical reliability of the substrate 20, it is necessary to confirm that the side etching amount of the first electrode pad 10 is a certain amount or less. Therefore, according to the present disclosure, the second electrode pad 11 is provided on the substrate 20 so that the side etching amount of the first electrode pad 10 can be confirmed.

### (Configuration of Semiconductor Substrate)

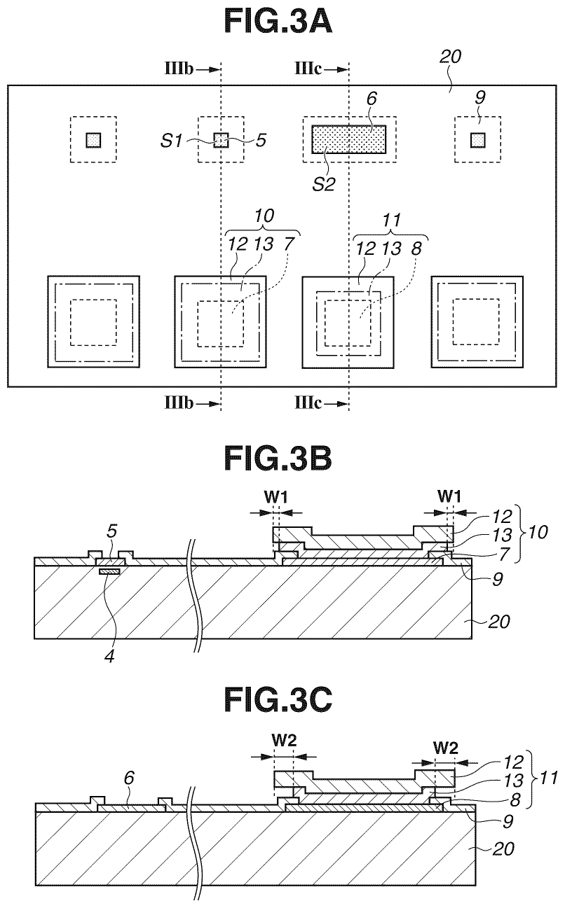

FIGS. 3A to 3C are schematic diagrams illustrating configurations of the electrode pads (the first electrode pad 10 and the second electrode pad 11) and the electrodes (the first electrode 5 and the second electrode 6 (described below)) of the substrate (semiconductor substrate) 20 according to the present embodiment. In FIGS. 3A to 3C, the through holes 35 and 36 illustrated in FIG. 1B are omitted, and the arrangement of each component is also simplified. FIG. 3A is a plan view as seen from the direction perpendicular to the surface of the substrate 20. FIG. 3B is a cross-sectional view taken along line IIIb-IIIb in FIG. 3A, illustrating the first electrode pad 10 and the first electrode 5.

FIG. 3C is a cross-sectional view taken along line IIIc-IIIc in FIG. 3A, illustrating the second electrode pad 11 and the second electrode 6.

According to the present embodiment, the configuration and manufacturing method of the second electrode pad 11 are the same as those of the above-described first electrode pad 10. On the other hand, an undercut width W2 from the first metal film 12 by side etching of the second metal film 13 in the second electrode pad 11 is larger than an undercut width W1 of the second metal film 13 in the first electrode pad 10. That is, W2/W1>1. In the present specification, the “undercut width” refers to a length by which a peripheral edge of the second metal film 13 is set back from a peripheral edge of the first metal film 12 in a direction parallel to the surface of the substrate 20. In other words, the “undercut width” is a distance between an end of the first metal film 12 and an end of the second metal film 13.

Since the first metal film 12 is a thin film having a film thickness of, for example, 300 to 500 nm, it is slightly deformed toward the substrate side from a horizontal position, starting from a side etching position described above. Thus, for example, the above-described side etching position can be identified from above by observation using an optical microscope, and the undercut width W2, namely the side etching amount of the second metal film 13 (the undercut width W2) can be measured non-destructively. Since the side etching amount of the second metal film 13 in the second electrode pad 11 is larger than that in the first electrode pad 10, evaluating the undercut width W2 of the second electrode pad 11 can ensure that the undercut width W1 of the first electrode pad 10 is smaller than the undercut width W2.

A method and mechanism for forming the undercut width W2 of the second electrode pad 11 to be larger than the undercut width W1 of the first electrode pad 10 are described below.

As illustrated in FIG. 3A, the first electrode pad 10, the first electrode 5 electrically connected to the first electrode pad 10, the second electrode pad 11, and the second electrode 6 electrically connected to the second electrode pad 11 are provided on the substrate 20. The second electrode 6 according to the present embodiment has a larger exposed area from the passivation film 9 than the first electrode 5.

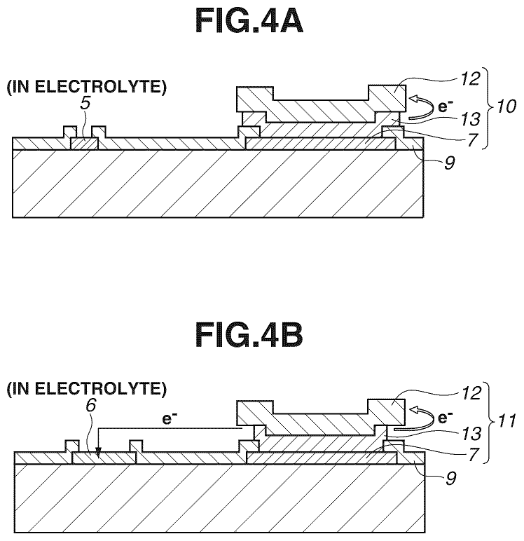

Here, FIGS. 4A and 4B are schematic diagrams illustrating galvanic corrosion that can occur if the substrate 20 is immersed in an electrolyte in a process for etching the second metal film 13 illustrated in FIG. 2F. FIG. 4A is the schematic diagram illustrating movement of electrons between the first electrode 5 and the first electrode pad 10. FIG. 4B is the schematic diagram illustrating movement of electrons between the second electrode 6 and the second electrode pad 11. In FIG. 4A, the energy generating element 4 is not illustrated. As described above, the first electrode pad 10 and the second electrode pad 11 have the configurations in which the first metal film 12, the second metal film 13, and the third metal film (first connection portion 7) are laminated. According to the present embodiment, as an example, the first metal film 12 is made of gold (Au), the second metal film 13 is made of titanium tungsten (TiW), and the third metal film is made of iridium (Ir). If such a dissimilar metal bonded body is placed in an electrolyte, a local cell may be formed between the electrolyte and the laminated metal films, which causes galvanic corrosion, and the metal with the higher ionization tendency among the metal films may dissolve. This is described in detail below.

In the following description, in a dissimilar metal bonded body, which is a bonded body of two types of metals, a metal with a lower ionization tendency is referred to as a noble metal, and a metal with a higher ionization tendency is referred to as a base metal. Regarding a dissolution rate of the base metal in the dissimilar metal bonded body, a relationship (Equation 1) relating to an area ratio of exposed surfaces of the base metal and the noble metal to the electrolyte is known. Here, P is the dissolution rate of the base metal, and P₀ is the dissolution rate in a case where the base metal exists alone. Further, Sn is the exposed area of the noble metal to the electrolyte, and Sb is the exposed area of the base metal to the electrolyte.

$$P = {P}_{0} \cdot \{ 1 + Sn / Sb \} \qquad ( Equation 1 )$$

In the electrolyte, electrons move from the second metal film 13 to the first metal film 12 that form the first electrode pad 10 and the second electrode pad 11, thereby causing a current to flow between the laminated first metal film 12 and second metal film 13. At the same time, in the electrolyte, electrons move from the second metal film 13 to the first electrode 5 and the second electrode 6, respectively, thereby causing a current to flow through the wiring (not illustrated) into the second metal films 13 of the first electrode pad 10 and the second electrode pad 11. Accordingly, the second metal film 13 dissolves as ions into the electrolyte (galvanic corrosion), and thus side etching of the second metal film 13 progresses in the first electrode pad 10 and the second electrode pad 11.

Here, in order to make the undercut width W2 in the second electrode pad 11 larger than the undercut width W1 in the first electrode pad 10, it can be seen from Equation (1) that the exposed area of the second electrode 6 to the electrolyte (the exposed area from the passivation film 9) is made larger than that of the first electrode 5. Accordingly, galvanic corrosion occurs more in the second electrode pad 11 than in the first electrode pad 10, resulting in larger side etching of the second metal film 13 in the second electrode pad 11 than in the first electrode pad 10. As described above, galvanic corrosion occurs if the noble metal and the base metal come into contact with the electrolyte while in contact with each other, so that galvanic corrosion occurs, for example, if the electrolyte is used in wet etching of the second metal film 13 as illustrated in FIG. 2F. Further, galvanic corrosion also occurs if the electrolyte is used as a stripping solution in a process for removing the mask pattern 15 as illustrated in FIG. 2G.

The ratio of the exposed areas of the first electrode 5 and the second electrode 6 from the passivation film 9 may be S2/S1>1, where S1 is the exposed area of the first electrode 5, and S2 is the exposed area of the second electrode 6. It is more desirable that S2/S1>10, and even more desirably S2/S1>100. It may be configured such that two or more second electrodes 6 are electrically connected to a single second electrode pad 11. In this case, for example, even if the exposed area per first electrode 5 is larger than the exposed area per second electrode 6, it is sufficient that the total exposed area of the plurality of electrically connected second electrodes 6 is larger than that of the first electrode 5.

In order to form the second electrode pad 11 having the undercut width W2 larger than the undercut width W1 of the first electrode pad 10, it is sufficient to adjust a magnitude relationship of the standard electrode potentials of a plurality of metal films forming the electrode pads. Specifically, the standard electrode potential of the second metal film 13 may be set lower than that of the third metal film (first connection portion 7), and the standard electrode potential of the first metal film 12 may be set higher than that of the second metal film 13. Here, comparing the standard electrode potentials of the second metal film 13 and the third metal film, the second metal film 13 is a base metal, and the third metal film is a noble metal. At this time, a standard electrode potential difference between the second metal film 13 and the third metal film is, for example, desirably 0.5 V or more in absolute value, more desirably 1.0 V or more, and even more desirably 2.0 V or more. A film thickness of the second metal film 13 is, for example, 100 to 300 nm. Further, comparing the standard electrode potentials of the first metal film 12 and the second metal film 13, the first metal film 12 is a noble metal, and the second metal film 13 is a base metal. At this time, a standard electrode potential difference between the first metal film 12 and the second metal film 13 is, for example, desirably 1.0 V or more in absolute value, more desirably 2.0 V or more, and even more desirably 2.5 V or more.

The film thickness of the first metal film 12 is, for example, 300 to 500 nm. If the film thickness of the first metal film 12 is 200 nm or more and 600 nm or less, deformation of an eaves shape of the first metal film 12 due to undercutting of the second metal film 13 can be easily observed.

The first electrode 5 and the second electrode 6 according to the present embodiment have a function of removing dirt such as burnt ejected liquid that adhere to the surface of the first electrode 5 due to the driving of the energy generating element 4. The energy generating element 4 according to the present embodiment is a heating resistance element. The second electrode 6 is a counter electrode to the first electrode 5 and is configured to cause an electrochemical reaction between a coating layer (burnt) covering the first electrode 5 and the ejected liquid by applying a voltage to the first electrode 5 and the second electrode 6 and to dissolve the coating layer into the ejected liquid. In other words, the second electrode 6 according to the present embodiment functions as the counter electrode for forming an electric field between itself and the first electrode 5.

Further, the second electrode 6 may have a function other than the counter electrode to the first electrode 5 and may also function as a monitor electrode used in an electrical test or during the manufacturing process.

If a process for applying an external force to at least the surface of the substrate 20 including the second electrode pad 11 is provided after the undercut shape is formed in the second electrode pad 11 by the above-described side etching, the undercut shape of the second electrode pad 11 is more likely to be displaced from the horizontal position. Thus, it is desirable as it further facilitates the measurement of the above-described undercut width W2. A process for applying the external force to the substrate surface including the second electrode pad 11 may be, for example, a process for attaching/peeling off a substrate protection tape. For example, before forming the common flow paths 32 and 33 in the substrate 20, the protection tape is attached to the surface of the substrate 20 on which the first electrode pad 10 and the second electrode pad 11 are formed. After the common flow paths 32 and 33 are formed by an arbitrary method such as dry etching or wet etching, the protection tape is peeled off. Since the external force is applied to the second electrode pad 11 by attaching the protection tape, the undercut shape of the first metal film 12 formed on an outer periphery of the second electrode pad 11 is displaced from the horizontal direction, resulting in an effect of facilitating the non-destructive measurement of the undercut width W2.

Other processes for applying the external force include contact with a cleaning liquid flow in a cleaning process, contact with an etching liquid flow used in a wet etching process, and contact with, for example, a nitrogen gas flow during drying. The process for applying the external force to the substrate surface including the second electrode pad 11 according to the present disclosure is not limited to the above-described processes and may be any other process.

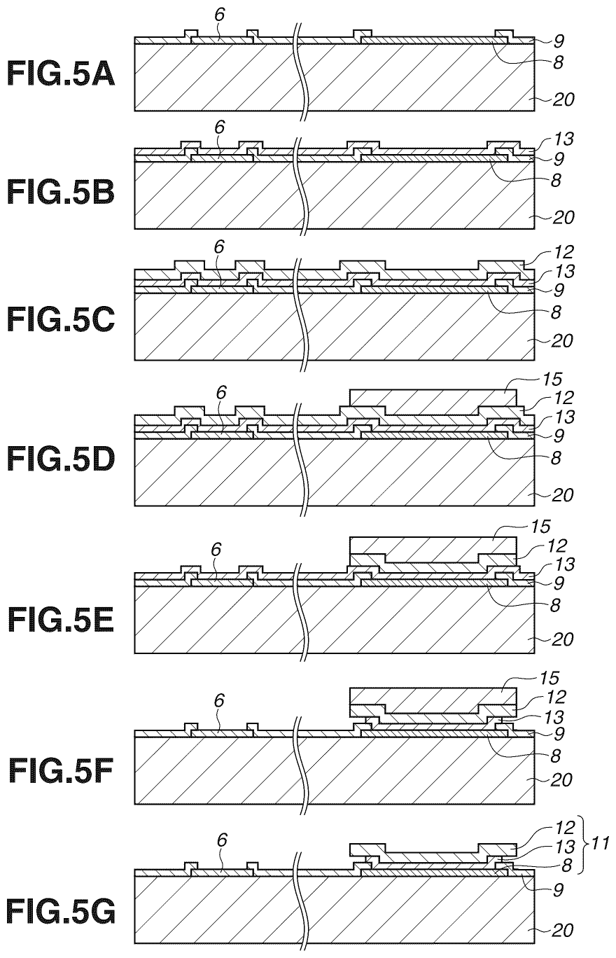

The second electrode 6 and the second electrode pad 11 can be manufactured in the same process as the first electrode 5 and the first electrode pad 10. FIGS. 5A to 5G are cross-sectional views illustrating processes for forming the second electrode 6 and the second electrode pad 11 and correspond to FIGS. 2A to 2G described above. According to the present embodiment, the first electrode 5, the second electrode 6, the third metal film (first connection portion 7) of the first electrode pad 10, and the third metal film (second connection portion 8) of the second electrode pad 11 are formed by patterning the same layer.

As described above, the undercut width of the base metal film in the first electrode pad 10 can be confirmed non-destructively by the second electrode 6 and the second electrode pad 11, thereby improving the electrical reliability of the wiring including the electrode pads.

### Second Embodiment

A second embodiment according to the present disclosure is described. Descriptions of parts that overlap with the first embodiment are omitted.

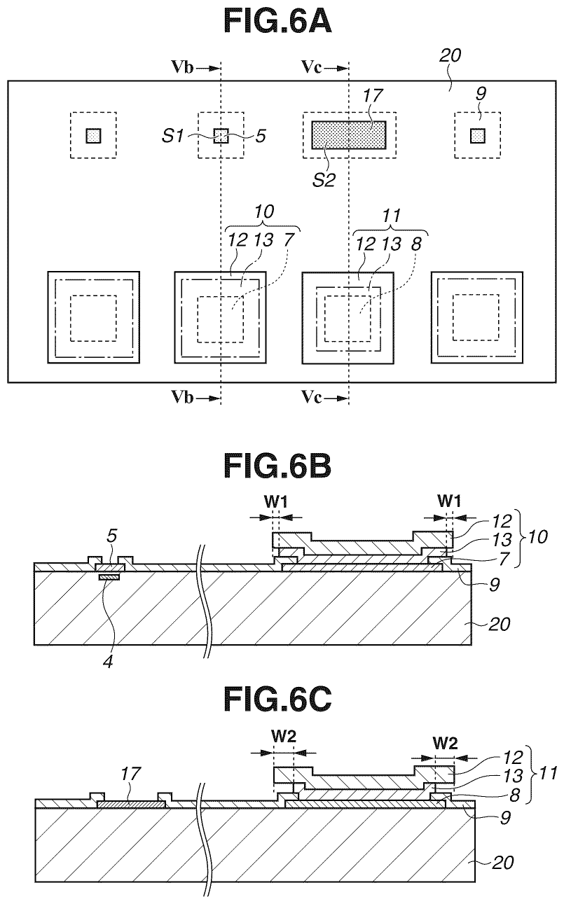

FIGS. 6A to 6C are schematic diagrams illustrating the configurations of the electrode pads (the first electrode pad 10 and the second electrode pad 11) and the electrodes (the first electrode 5 and a second electrode 17) of the substrate 20 according to the second embodiment. In FIGS. 6A to 6C, the through holes 35 and 36 illustrated in FIG. 1B are omitted, and the arrangement of each component is also simplified. FIG. 6A is a plan view as seen from the direction perpendicular to the surface of the substrate 20. FIG. 6B is a cross-sectional view taken along line Vb-Vb in FIG. 6A, illustrating the first electrode pad 10 and the first electrode 5. FIG. 6C is a cross-sectional view taken along line Vc-Vc in FIG. 6A, illustrating the second electrode pad 11 and the second electrode 17.

The present embodiment is different from the first embodiment in that the second electrode 17 is formed of a fourth metal film with a higher standard electrode potential than that of the third metal film forming the first electrode 5. Accordingly, a standard electrode potential difference between the second electrode 17 and the second metal film 13 is greater than a standard electrode potential difference between the first electrode 5 and the second metal film 13. Thus, a standard electrode potential difference between the second electrode pad 11 and the second metal film 13, which is a base metal, becomes large, and side etching due to galvanic corrosion is larger in the second electrode pad 11 than in the first electrode pad 10. In other words, the undercut width W2 of the undercut shape of the first metal film 12 formed on the outer periphery of the second electrode pad 11 is larger than the undercut width W1 formed on the outer periphery of the first electrode pad 10.

Thus, as described in the first embodiment, the undercut width W2 of the second electrode pad 11 can ensure that the undercut width W1 of the first electrode pad 10 is smaller than the undercut width W2. Therefore, the reliability of the wiring including the electrode pads can be improved.

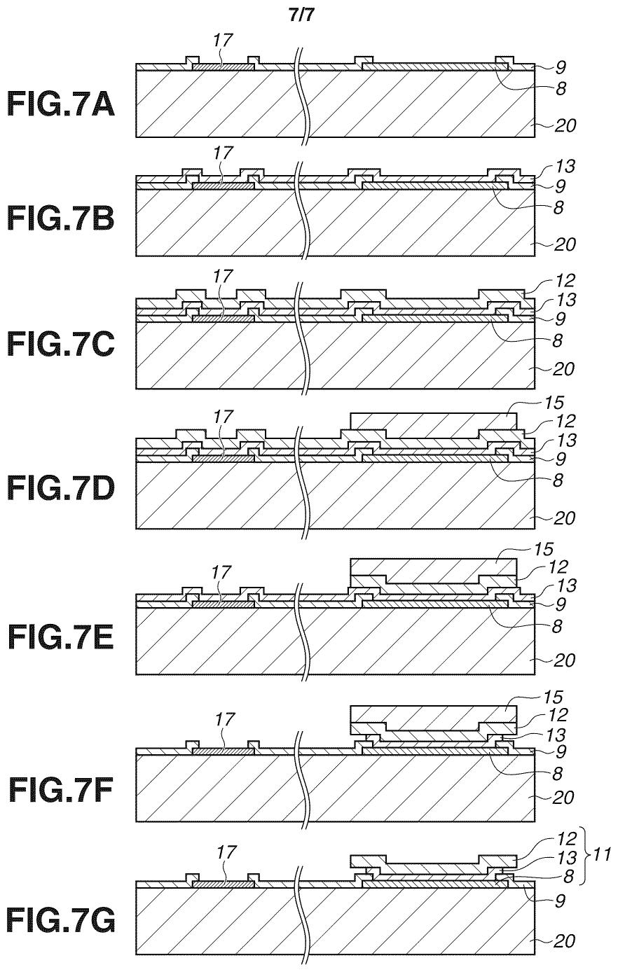

A method for manufacturing a semiconductor substrate according to the second embodiment of the present disclosure is described with reference to FIGS. 2A to 2G and 7A to 7G. According to the present embodiment, the cross-sectional position taken along line Vb-Vb in FIG. 6A corresponds to FIGS. 2A to 2G, and the cross-sectional position taken along line Vc-Vc in FIG. 6A corresponds to FIGS. 7A to 7G.

First, as illustrated in FIGS. 2A and 7A, the substrate 20 is prepared on which the third metal film, which is the first connection portion 7 of the first electrode pad 10, the third metal film, which is the second connection portion 8 of the second electrode pad 11, the first electrode 5, and the second electrode 17 are provided. According to the present embodiment, the first electrode 5, the first connection portion 7, and the second connection portion 8 are formed of the same third metal film. Since the third metal film is exposed from the passivation film 9 as the first electrode 5 and the second electrode 17, it is desirable to use a material that is resistant to a manufacturing process. Further, the third metal film is the electrical connection portion between the wiring of the first electrode pad 10 and the second electrode pad 11, so that it is desirable to use a metal or a metal compound with good electrical conductivity. According to the present embodiment, iridium is used as an example of a material of the third metal film, but other materials may also be used. The third metal film may be formed using an arbitrary method, such as sputtering film deposition or vacuum vapor film deposition.

The second electrode 17 is formed of the fourth metal film with a higher standard electrode potential than that of the third metal film forming the first electrode 5. The fourth metal film may be made of, for example, platinum (standard electrode potential: +1.188 V), but other materials may also be used. The processes illustrated in FIGS. 2B to 2G and 7B to 7G are the same as those described in the first embodiment.

The second electrode 17 is formed of a metal film with a higher standard electrode potential than that of the first electrode 5. Thus, the undercut width of the second metal film 13, which is a base metal, in the electrode pads due to galvanic corrosion is larger in the second electrode pad 11 than in the first electrode pad 10. In other words, the undercut width W2 of the first metal film 12 formed on the outer periphery of the second electrode pad 11 is larger than the undercut width W1 formed on the outer periphery of the first electrode pad 10. Therefore, similar to the first embodiment, evaluating the undercut width W2 of the second electrode pad 11 can ensure that the undercut width W1 of the first electrode pad 10 is smaller than the undercut width W2.

As described above, the undercut width of the second metal film 13, which is the base metal film, in the first electrode pad 10 can be confirmed non-destructively by the second electrode 17 and the second electrode pad 11, thereby improving the reliability of the wiring including the electrode pads.

The exposed area S2 of the second electrode 17 illustrated in FIG. 6A is larger than the exposed area S1 of the first electrode 5 illustrated in FIG. 6A, but the present embodiment is not limited to this. It is more desirable that S2/S1>1 from the relationship of Equation (1). However, as long as the standard electrode potential difference between the second electrode 17 and the second metal film 13 is greater than the standard electrode potential difference between the first electrode 5 and the second metal film 13, and thus the undercut width W2 can be made larger than the undercut width W1, there is no limitation on the area ratio of S2 to S1.

### Other Embodiment

The present disclosure includes following methods and configurations.

### (Method 1)

A method for manufacturing a semiconductor substrate that includes, on a substrate, a first electrode, a second electrode having an area larger than that of the first electrode, a first electrode pad connected to the first electrode via a first connection portion, and a second electrode pad connected to the second electrode via a second connection portion, the method includes: forming the first electrode, the second electrode, and the first connection portion and the second connection portion each including a third metal film on the substrate; forming a second metal film having a standard electrode potential lower than that of the third metal film in a region including the first electrode, the second electrode, the first connection portion, and the second connection portion; forming a first metal film having a standard electrode potential higher than that of the second metal film on the second metal film; and forming the first electrode pad and the second electrode pad by patterning the first metal film and the second metal film, wherein, during the forming the first electrode pad and the second electrode pad, the first electrode, the second electrode, the first electrode pad, and the second electrode pad are exposed to an electrolyte.

### (Method 2)

A method for manufacturing a semiconductor substrate that includes, on a substrate, a first electrode, a second electrode, a first electrode pad connected to the first electrode via a first connection portion, and a second electrode pad connected to the second electrode via a second connection portion, the method includes: forming the first electrode, the first connection portion, and the second connection portion from a third metal film; forming the second electrode from a fourth metal film having a standard electrode potential higher than that of the third metal film; forming a second metal film having a standard electrode potential lower than that of the third metal film in a region including the first electrode, the second electrode, the first connection portion, and the second connection portion; forming a first metal film having a standard electrode potential higher than that of the second metal film on the second metal film; and forming the first electrode pad and the second electrode pad by patterning the first metal film and the second metal film, wherein, during the forming the first electrode pad and the second electrode pad, the first electrode, the second electrode, the first electrode pad, and the second electrode pad are exposed to an electrolyte.

### (Method 3)

The method according to method 1 or 2, wherein the electrolyte is a resist stripping solution.

### (Method 4)

The method according to any one of methods 1 to 3, further includes applying an external force to the second electrode pad after the forming the first electrode pad and the second electrode pad.

### (Method 5)

The method according to method 4, wherein the applying the external force includes attaching a tape to a surface of the substrate including the second electrode pad and peeling off the tape.

### (Method 6)

The method according to any one of methods 1 to 5, wherein a standard electrode potential difference between the first metal film and the second metal film is 2.5 V or more, and a standard electrode potential difference between the second metal film and the third metal film is 2.0 V or more.

### (Method 7)

The method according to any one of methods 1 to 6, further includes forming a passivation film in a region including the first electrode, the second electrode, the first connection portion, and the second connection portion before the forming the second metal film.

### (Method 8)

The method according to method 7, further includes patterning the passivation film so that an area of the second electrode exposed from the passivation film is larger than an area of the first electrode exposed from the passivation film.

### (Method 9)

The method according to method 8, wherein the area of the second electrode exposed from the passivation film is a total area of a plurality of the second electrodes electrically connected to each other.

### (Method 10)

The method according to any one of methods 1 to 9, wherein the first metal film is made of gold, the second metal film is made of titanium tungsten, and the third metal film is made of iridium.

### (Method 11)

A method for manufacturing a liquid ejection head includes:
the method according to any one of methods 1 to 10; and
forming, on the substrate, a nozzle plate that includes an ejection port for ejecting liquid.

### (Configuration 12)

A semiconductor substrate that includes, on a substrate, a first electrode, a second electrode, a first electrode pad connected to the first electrode via a first connection portion, and a second electrode pad connected to the second electrode via a second connection portion, wherein each of the first electrode pad and the second electrode pad includes a first metal film, and a second metal film that is in contact with the first connection portion or the second connection portion and has a standard electrode potential lower than that of the first metal film, wherein each of the first electrode, the second electrode, the first connection portion, and the second connection portion includes a third metal film having a standard electrode potential higher than that of the first metal film,

wherein S2/S1>1

where S1 is an exposed area of the first electrode, and S2 is an exposed area of the second electrode in the first electrode, the second electrode, the first electrode pad, and the second electrode pad, and

wherein W2/W1>1

where W1 is an undercut width of the second metal film with respect to an end of the first metal film of the first electrode pad in a direction parallel to a surface of the substrate, and W2 is an undercut width of the second metal film with respect to the end of the first metal film of the second electrode pad.

### (Configuration 13)

A semiconductor substrate that includes, on a substrate, a first electrode, a second electrode, a first electrode pad connected to the first electrode via a first connection portion, and a second electrode pad connected to the second electrode via a second connection portion, wherein each of the first electrode pad and the second electrode pad includes a first metal film, and a second metal film that is in contact with the first connection portion or the second connection portion and has a standard electrode potential lower than that of the first metal film, wherein each of the first electrode, the first connection portion, and the second connection portion includes a third metal film having a standard electrode potential higher than that of the second metal film, wherein the second electrode includes a fourth metal film having a standard electrode potential higher than that of the third metal film, and

wherein W2/W1>1

where W1 is an undercut width of the second metal film with respect to an end of the first metal film of the first electrode pad in a direction parallel to a surface of the substrate, and W2 is an undercut width of the second metal film with respect to the end of the first metal film of the first electrode pad.

### (Configuration 14)

The semiconductor substrate according to configuration 12 or 13, wherein a standard electrode potential difference between the first metal film and the second metal film is 2.5 V or more, and a standard electrode potential difference between the second metal film and the third metal film is 2.0 V or more.

### (Configuration 15)

The semiconductor substrate according to any one of configurations 12 to 14, wherein the first metal film is made of gold, the second metal film is made of titanium tungsten, and the third metal film is made of iridium.

### (Configuration 16)

The semiconductor substrate according any one of configurations 12 to 15, wherein a film thickness of the second metal film is 200 nm or more and 600 nm or less.

### (Configuration 17)

A liquid ejection head includes:
the semiconductor substrate according any one of configurations 12 to 16; and
a nozzle plate that is formed on the substrate and includes an ejection port for ejecting liquid.

### (Configuration 18)

The liquid ejection head according to configuration 17, wherein the substrate includes a heating resistance element below the first electrode.

### (Configuration 19)

The liquid ejection head according to configuration 17 or 18, wherein the second electrode is a counter electrode to the first electrode.

### (Configuration 20)

The liquid ejection head according to configuration 18,
wherein the second electrode is a counter electrode to the first electrode, and
wherein the liquid ejection head is configured to apply a voltage to the first electrode and the second electrode to cause an electrochemical reaction between a coating layer that covers the first electrode and ejected liquid and dissolve the coating layer to into the ejected liquid.

### EXAMPLE

The present disclosure is described in detail below with reference to specific examples. However, the present disclosure is not limited to the following examples.

A semiconductor substrate and a liquid ejection head described according to the first embodiment were manufactured. More specifically, they were manufactured by the method illustrated in FIGS. 2A to 2G. On the substrate 20, the first electrode 5, the second electrode 6, the first connection portion of the first electrode pad 10, and the second connection portion of the second electrode pad were each formed of an iridium (Ir) film as the third metal film. Next, the passivation film 9 was formed over a region that includes at least the first electrode 5, the second electrode 6, the first connection portion, and the second connection portion, in such a manner that the passivation film 9 was formed to cover openings exposing the first electrode 5, the second electrode 6, the first connection portion, and the second connection portion, respectively. Here, an exposed area of the second electrode 6 from the passivation film 9 was made larger than that of the first electrode 5. The exposed area of one first electrode 5 from the passivation film 9 was 400 μm², while the exposed area of the second electrode 6 from the passivation film 9 was 100000 μm². The exposed area of the second electrode 6 is the total value of the exposed areas of a plurality of electrically connected second electrodes 6.

Next, a titanium tungsten (TiW) film was formed by sputtering to a film thickness of 200 nm as the second metal film 13 that forms the first electrode pad 10 and the second electrode pad 11. Further, a gold (Au) film was formed by sputtering to a film thickness of 400 nm as the first metal film 12 that forms the first electrode pad 10 and the second electrode pad 11. Here, the relationship between the standard electrode potentials of the first metal film 12 (Au), the second metal film 13 (TiW), and the third metal film (Ir) is Au (+1.83 V)>TiW (−1.1 V), and Ir (+1.16 V)>TiW (−1.1 V). Further, the standard electrode potential difference between the first metal film 12 (Au) and the second metal film 13 (TiW) was approximately 2.9 V in absolute value, and the standard electrode potential difference between the second metal film 13 (TiW) and the third metal film (Ir) was approximately 2.2 V in absolute value.

Next, the first metal film 12 and the second metal film 13 were patterned to form the first electrode pad 10 and the second electrode pad 11. Subsequently, the through holes 35 and 36 and the common flow paths 32 and 33 were formed. In the process for forming the common flow paths 32 and 33, the protection tape was attached on the surface of the substrate 20 on which the first electrode pad 10 and the second electrode pad 11 were formed, and then was peeled off after the common flow paths 32 and 33 were formed. Since the external force was applied to the second electrode pad 11 by attaching the protection tape, the undercut shape of the first metal film 12 formed on the outer periphery of the second electrode pad 11 was displaced from the horizontal direction, making it easier to measure the undercut width W2 non-destructively.

Subsequently, the nozzle plate 30 including the individual liquid chamber 34 and the ejection port 31 was formed on the substrate 20, and thus the liquid ejection head was manufactured.

In an inspection after the manufacturing process, the undercut shape width W2 of the first metal film 12 (a side etching width of the second metal film 13) formed on the outer periphery of the second electrode pad 11 was measured non-destructively from a top surface using an optical microscope, and the undercut width W2 was approximately 4 μm. Here, a calibration curve indicating the value of the undercut width W1 with respect to the undercut width W2 in the exposed areas of the first electrode 5 and the second electrode 6 of the example was acquired in advance by experiment. From the calibration curve, it was confirmed that if the undercut width of the second metal film 13 formed on the outer periphery of the second electrode pad 11 is approximately 4 μm, the undercut width W2 of the second metal film 13 formed on the outer periphery of the first electrode pad 10 is approximately 40 nm. Since the above-described side etching widths of both the first electrode pad 10 and the second electrode pad 11 do not reach the ends of the openings on the passivation film 9, the reliability of the wiring can be improved.

According to the present example, the second electrode 6 functions as a counter electrode for applying a reverse potential between it and the first electrode 5 to form an electric field, thereby removing dirt (burnt) caused by liquid (ink) adhering to the surface of the first electrode 5.

According to the present disclosure, it is possible to provide a semiconductor substrate with improved wiring reliability and a method for manufacturing the same.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-020732, filed Feb. 12, 2025, which is hereby incorporated by reference herein in its entirety.

What is claimed is:

1. A method for manufacturing a semiconductor substrate that includes, on a substrate, a first electrode, a second electrode having an area larger than that of the first electrode, a first electrode pad connected to the first electrode via a first connection portion, and a second electrode pad connected to the second electrode via a second connection portion, the method comprising:
forming the first electrode, the second electrode, and the first connection portion and the second connection portion each including a third metal film on the substrate;
forming a second metal film, having a standard electrode potential lower than that of the third metal film, in a region including the first electrode, the second electrode, the first connection portion, and the second connection portion;
forming a first metal film, having a standard electrode potential higher than that of the second metal film, on the second metal film; and
forming the first electrode pad and the second electrode pad by patterning the first metal film and the second metal film,
wherein, during the forming the first electrode pad and the second electrode pad, the first electrode, the second electrode, the first electrode pad, and the second electrode pad are exposed to an electrolyte.

2. The method according to claim 1, wherein the electrolyte is a resist stripping solution.

3. The method according to claim 1, further comprising applying an external force to the second electrode pad after the forming the first electrode pad and the second electrode pad.

4. The method according to claim 3, wherein the applying the external force includes:
attaching a tape to a surface of the substrate including the second electrode pad, and
peeling off the tape.

5. The method according to claim 1, wherein a standard electrode potential difference between the first metal film and the second metal film is 2.5 V or more, and a standard electrode potential difference between the second metal film and the third metal film is 2.0 V or more.

6. The method according to claim 1, further comprising forming a passivation film in a region including the first electrode, the second electrode, the first connection portion, and the second connection portion before the forming the second metal film.

7. The method according to claim 6, further comprising patterning the passivation film so that an area of the second electrode exposed from the passivation film is larger than an area of the first electrode exposed from the passivation film.

8. The method according to claim 7, wherein the area of the second electrode exposed from the passivation film is a total area of a plurality of the second electrodes electrically connected to each other.

9. The method according to claim 1, wherein the first metal film is made of gold, the second metal film is made of titanium tungsten, and the third metal film is made of iridium.

10. A method for manufacturing a semiconductor substrate that includes, on a substrate, a first electrode, a second electrode, a first electrode pad connected to the first electrode via a first connection portion, and a second electrode pad connected to the second electrode via a second connection portion, the method comprising:
forming the first electrode, the first connection portion, and the second connection portion from a third metal film;
forming the second electrode from a fourth metal film having a standard electrode potential higher than that of the third metal film;
forming a second metal film, having a standard electrode potential lower than that of the third metal film, in a region including the first electrode, the second electrode, the first connection portion, and the second connection portion;
forming a first metal film, having a standard electrode potential higher than that of the second metal film, on the second metal film; and
forming the first electrode pad and the second electrode pad by patterning the first metal film and the second metal film,
wherein, during the forming the first electrode pad and the second electrode pad, the first electrode, the second electrode, the first electrode pad, and the second electrode pad are exposed to an electrolyte.

11. A semiconductor substrate comprising: on a substrate, a first electrode, a second electrode, a first electrode pad connected to the first electrode via a first connection portion, and a second electrode pad connected to the second electrode via a second connection portion,
wherein each of the first electrode pad and the second electrode pad includes a first metal film, and a second metal film that is in contact with the first connection portion or the second connection portion and has a standard electrode potential lower than that of the first metal film,
wherein each of the first electrode, the second electrode, the first connection portion, and the second connection portion includes a third metal film having a standard electrode potential higher than that of the first metal film,
wherein S2/S1>1
where S1 is an exposed area of the first electrode, and S2 is an exposed area of the second electrode in the first electrode, the second electrode, the first electrode pad, and the second electrode pad, and
wherein W2/W1>1
where W1 is an undercut width of the second metal film with respect to an end of the first metal film of the first electrode pad in a direction parallel to a surface of the substrate, and W2 is an undercut width of the second metal film with respect to the end of the first metal film of the first electrode pad.

12. The semiconductor substrate according to claim 11, wherein a standard electrode potential difference between the first metal film and the second metal film is 2.5 V or more, and a standard electrode potential difference between the second metal film and the third metal film is 2.0 V or more.

13. The semiconductor substrate according to claim 11, wherein the first metal film is made of gold, the second metal film is made of titanium tungsten, and the third metal film is made of iridium.

14. The semiconductor substrate according to claim 11, wherein a film thickness of the second metal film is 200 nm or more and 600 nm or less.
